(19) United States
(12) Patent Application Publication
(10) Pub. No.: US 2011/0234788 A1
(43) Pub. Date: Sep. 29, 2011

(54) ASSEMBLY INSPECTION APPARATUS AND ASSEMBLY PROCESSING APPARATUS USING THE SAME

(76) Inventors: Naoki Koike, Kanagawa (JP); Kimihiro Wakabayashi, Kanagawa (JP)

(21) Appl. No.: 12/951,847

(22) Filed: Nov. 22, 2010

(30) Foreign Application Priority Data
Mar. 29, 2010 (JP) P2010-076211

(51) Int. Cl. H04N 7/18

(52) U.S. Cl. 348/95; 348/E07.085

(57) ABSTRACT

An assembly inspection apparatus includes a marker having four or more unit pattern marks which are provided, at a predetermined positional relationship, in a portion of an assembly component to be put into a receiving assembly component and which are formed in such a way that a density pattern sequentially changes from a center position to a periphery of the pattern mark; an imaging tool that is disposed opposite the assembly component put into the receiving assembly component and that captures an image of the marker; a layout information recognition block that recognizes layout information about a position and an attitude of the assembly component put into the receiving assembly component by use of at least imaging information about the marker whose image has been captured by the imaging tool; and an assembly inspection block that inspects whether or not a superior assembly state is achieved.

### CROSS-REFERENCE TO RELATED APPLICATION

This application is based on and claims priority under 35 USC 119 from Japanese Patent Application No. 2010-076211 filed on Mar. 29, 2010.

### BACKGROUND

### Technical Field

The present invention relates to an assembly inspection apparatus and an assembly processing apparatus using the same.

### SUMMARY

According to an aspect of the invention, an assembly inspection apparatus includes:

a marker having four or more unit pattern marks which are provided, at a predetermined positional relationship, in a portion of an assembly component to be put into a receiving assembly component and which are formed in such a way that a density pattern sequentially changes from a center position to a periphery of the pattern mark;

an imaging tool that is disposed opposite the assembly component put into the receiving assembly component and that captures an image of the marker;

a layout information recognition block that recognizes layout information about a position and an attitude of the assembly component put into the receiving assembly component by use of at least imaging information about the marker whose image has been captured by the imaging tool; and

an assembly inspection block that inspects, according to layout information recognized by the layout information recognition block, whether or not a superior assembly state is achieved.

### BRIEF DESCRIPTION OF THE DRAWINGS

Exemplary embodiments of the invention will be described in detail based on the following figures, wherein:

FIG. 1A is a descriptive view showing an overview of exemplary embodiments of an assembly inspection apparatus and an assembly processing apparatus to which the present invention applies, and FIG. 1B is a descriptive view showing an example marker used in the exemplary embodiment;

FIG. 2 is a descriptive view showing an overview of assembly processing of the assembly processing apparatus including the assembly inspection apparatus shown in FIG. 1;

FIG. 3 is a descriptive view showing an overall structure of the assembly processing apparatus of the first exemplary embodiment;

FIG. 4A is a descriptive view showing an example assembly component provided with a pattern marker used in the first exemplary embodiment, FIG. 4B is a descriptive view showing an overall structure of the pattern marker, and FIGS. 4C and 4D are descriptive views showing an example structure of a unit pattern mark;

FIG. 5A is a descriptive view schematically showing a characteristic of the unit pattern mark of the pattern marker used in the first exemplary embodiment, and FIG. 5B is a descriptive view showing an example structure of a marker used in a comparative mode;

FIG. 6 is a descriptive view showing a principle on the basis of which a position and an attitude of an assembly component are determined by means of the pattern marker used in the first exemplary embodiment;

FIG. 7 is a descriptive view showing an example manufacture of the pattern marker used in the first exemplary embodiment;

FIG. 8 is a descriptive view showing an example structure and dimensions of the pattern marker used in the first exemplary embodiment;

FIG. 9A is a descriptive view showing a configuration in which an imaging plane of a camera serving as an imaging tool is set at a face-up measurement position with respect to a point of center origin of the pattern marker, FIG. 9B is a descriptive view showing a configuration in which the imaging plane of the camera serving as the imaging tool is moved in parallel to the face-up measurement position shown in FIG. 9A, and FIG. 9C is a descriptive view showing a configuration in which the imaging plane of the camera serving as the imaging tool is placed at a non-face-up measurement position that is not parallel to an indication plane of the pattern marker;

FIG. 10A is a descriptive view schematically showing a configuration in which the imaging plane of the camera serving as the imaging tool is placed at the face-up measurement position with respect to the point of center origin of the pattern marker, and FIG. 10B is a descriptive view showing measurement accuracy achieved in the case shown in FIG. 10A;

FIG. 11 is a flowchart showing an assembly processing process of the assembly processing apparatus of the first exemplary embodiment;

FIG. 12 is a descriptive view schematically showing an assembly processing process shown in FIG. 11;

FIGS. 13A to 13D show layout information pertaining to positions and attitudes that may be inspected in an assembly inspection process, wherein FIG. 13A shows a lift occurred in a Z-axis direction, FIG. 13B shows an inclination occurred with reference to a Y axis, FIG. 13C shows positional displacement occurred in both X-axis and Y-axis directions, and FIG. 14D shows a rotational displacement occurred with reference to the Z axis;

FIG. 14A is a descriptive view schematically showing an example assembly processing apparatus of a comparative mode, and FIG. 14B is a descriptive view showing a normal assembly state yielded by the assembly processing apparatus when viewed in direction B shown in FIG. 14A;

FIGS. 15A to 15D show an example assembly processing apparatus of the comparative mode, wherein FIG. 15A shows a lift occurred in the Z-axis direction, FIG. 15B shows inclinations occurred with reference to the X axis and the Y axis, FIG. 15C shows positional displacements occurred in both the X-axis direction and the Y-axis direction, FIG. 15D shows a mode for inspecting a rotational displacement occurred with reference to the Z axis;

FIG. 16 is a descriptive view showing a principal block of an assembly processing apparatus of a second exemplary embodiment;

FIG. 17 is a flowchart showing an assembly processing process employed in the assembly processing apparatus of the second exemplary embodiment;

FIG. 18 is a descriptive view schematically showing the assembly processing process shown in FIG. 17;

FIG. 19A is a descriptive view showing a principal block of an assembly processing apparatus serving as an assembly processing apparatus of a third exemplary embodiment, and FIG. 19B is a descriptive view showing a principal block of a modification of the assembly processing apparatus of the third exemplary embodiment;

FIGS. 20A and 20B are descriptive views showing an example structure of a pattern marker card used in the third exemplary embodiment;

FIGS. 21A and 21B are descriptive views showing example fixing of the pattern marker card used in the third exemplary embodiment, wherein (I) is a cross sectional descriptive view and (II) is a planer descriptive view of the pattern marker card;

FIGS. 22A and 22B are descriptive views showing another example of the pattern marker card used in the third exemplary embodiment, wherein (I) is a cross sectional descriptive view and (II) is a planer descriptive view of the pattern marker card; and

FIGS. 23A and 23B show a principal block of an assembly processing apparatus (a connector device) of a fourth exemplary embodiment, wherein FIG. 23A is a descriptive view showing a yet-to-be-assembled connector device, and FIG. 23B is a descriptive view showing an assembled connector device.

### DETAILED DESCRIPTION

### Summary of Exemplary Embodiments

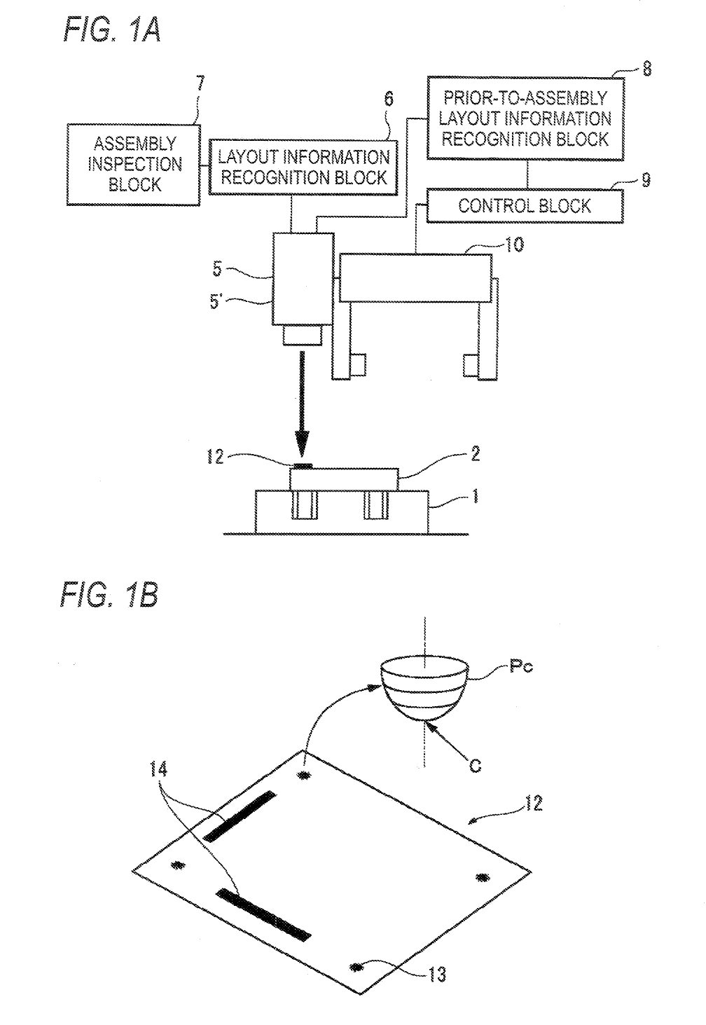

FIG. 1A shows an overview of exemplary embodiments of an assembly inspection apparatus to which the present invention applies and an assembly processing apparatus using the same.

In the drawings, as shown in FIGS. 1A and 1B, one typical configuration of the assembly inspection apparatus includes a marker 12 having four or more unit pattern marks 13 which are provided, at a predetermined positional relationship, in a portion of an assembly component 2 to be put into a receiving assembly component 1 and which are formed in such a way that a density pattern Pc sequentially changes from a center position C to a periphery of the pattern mark; an imaging tool 5 that is disposed opposite the assembly component 2 put into the receiving assembly component 1 and that captures an image of the marker 12; a layout information recognition block 6 that recognizes layout information about a position and an attitude of the assembly component 2 put into the receiving assembly component 1 by use of at least imaging information about the marker 12 whose image has been captured by the imaging tool 5; and an assembly inspection block 7 that inspects, according to layout information recognized by the layout information recognition block 6, whether or not a superior assembly state is achieved.

An assembly processing apparatus using an assembly inspection apparatus includes the foregoing assembly inspection apparatus; prior-to-assembly imaging tool 5′ that is disposed opposite a yet-to-be-assembled assembly component 2 to be put into a receiving assembly component 1 and that captures an image of a marker 12 on the assembly component 2; a prior-to-assembly layout information recognition block 8 that recognizes layout information about a position and an attitude of the yet-to-be-assembled assembly component 2 put into the receiving assembly component, by use of at least imaging information about the marker 12 whose image has been captured by the prior-to-assembly imaging tool 5′; a control block 9 that generates a control signal according to layout information about the position and the attitude of the assembly component 2 recognized by the prior-to-assembly layout information recognition block 8 and that controls operation for collecting the assembly component 2 and operation for putting the assembly component 2 into the receiving assembly component 1; and a processing mechanism 10 that performs the operation for collecting the assembly component 2 and the operation for putting the assembly component 2 into the receiving assembly component 1, according to the control signal generated by the control block 9.

In connection with such technical means, the marker 12 requires four unit pattern marks 13 or more. The essential requirement for the unit pattern mark 13 is that the density pattern Pc will sequentially change. The unit pattern mark is not limited to a configuration in which the center position C exhibits a higher density than that achieved at a periphery of the pattern mark. The unit pattern mark also includes a configuration in which the center position C exhibits a lower density than does the periphery of the pattern mark. A technique for displaying a change in the density pattern Pc of the unit pattern mark 13 with a gradation is also mentioned. However, displaying the change in density pattern is not limited to the gradation. It is also possible to display the change in the form of dot images (dots). Although the unit pattern marks 13 may directly be drawn by use of a printing technique, the marks may also be provided by utilization of retroreflection, like an inscribed surface pattern formed during a die molding operation; for instance, a corner cube (a tool that reflects light, or the like, to its original direction by utilization of a property of a corner of a cubical inner surface).

Further, although the imaging tool 5 may be used in numbers, one imaging tool is preferable in view of simplification of an apparatus configuration.

Moreover, the essential requirement for the layout information recognition block 6 is to capture an image of the marker 12 on the receiving assembly component 1 with the imaging tool 5 and recognize layout information about a position and an attitude of the assembly component from the information and according to a predetermined algorithm.

Further, the essential requirement for the assembly inspection block 7 is to determine an allowable range in advance and perform inspection about an assembly whether or not a resultant assembly falls within the allowable range.

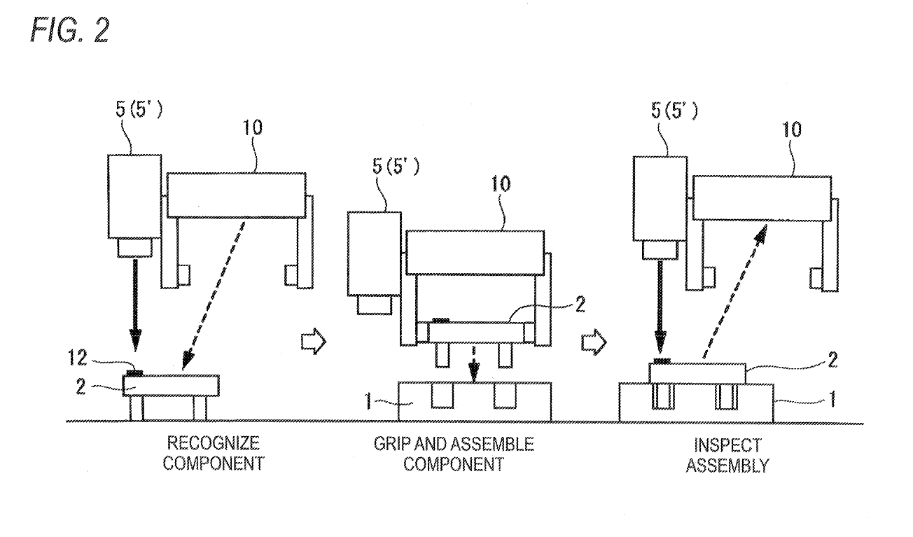

As shown in FIG. 2, the assembly processing apparatus of the configuration recognizes the layout information about the assembly component 2, performs operation for collecting the assembly component 2, and performs operation for putting the assembly component 2 into the receiving assembly component 1. In this case, the essential requirement for the receiving assembly component 1 is to be placed at a predetermined area.

As shown in FIG. 2, the assembly inspection apparatus performs assembly inspection after the assembly component 2 has been put into the receiving assembly component 1.

As shown in FIGS. 1A and 1B, another typical configuration of the assembly inspection apparatus includes a marker 12 having four or more unit pattern marks 13 which are provided, at a predetermined positional relationship, in a portion of a receiving assembly component 1, a portion of an assembly base (not shown) on a predetermined area of which the receiving assembly component 1 is to be placed and a portion of an assembly component 2 to be put into the receiving assembly component 1 and which are formed in such a way that a density pattern Pc sequentially changes from a center position C to a periphery of the pattern mark; an imaging tool 5 that is disposed opposite the assembly component 2 put into the receiving assembly component 1 and that captures an image of the marker 12 on the receiving assembly component 1 or an image of the marker 12 on the assembly base and an image of the marker 12 on the assembly component 2; a layout information recognition block 6 that recognizes layout information about a position and an attitude of the receiving assembly component 1 and a position and an attitude of the assembly component 2 put into the receiving assembly component 1, by use of at least imaging information about the marker 12 whose image has been captured by the imaging tool 5; and an assembly inspection block 7 that inspects, according to both of the pieces of layout information recognized by the layout information recognition block 6, whether or not a superior assembly state is achieved.

As shown in FIGS. 1A and 1B, an assembly processing apparatus comprising such an assembly inspection apparatus includes an assembly inspection apparatus for inspecting a state of the assembly component 2 put into the receiving assembly component 1; a prior-to-assembly imaging tool 5′ that is disposed opposite the assembly component 2 to be put into the receiving assembly component 1 and captures an image of the marker 12 on the assembly component 2 and an image of the marker 12 on the yet-to-be-assembled receiving assembly component 1 into which the receiving assembly component 2 is not yet put or that is disposed opposite an assembly base (not shown) and captures an image of the marker 12 on the receiving assembly component 1 or the image of the marker 12 on the assembly base; a prior-to-assembly layout information recognition block 8 that recognizes layout information about a position and an attitude of the yet-to-be-assembled assembly component 2 not yet put into the receiving assembly component 1 and layout information about a position and an attitude of the receiving assembly component 1, by use of at least imaging information about the marker 12 whose image has been captured by the prior-to-assembly imaging tool 5′; a control block 9 that generates a control signal according to layout information about the position and the attitude of the assembly component 2 recognized by the prior-to-assembly layout information recognition block 8 and the layout information about the position and the attitude of the receiving assembly component 1 recognized by the prior-to-assembly layout information recognition block 8, and that controls operation for collecting the assembly component 2 and operation for putting the assembly component 2 into the receiving assembly component 1; and a processing mechanism 10 that performs operation for collecting the assembly component 2 and operation for putting the assembly component 2 into the receiving assembly component 1, according to the control signal generated by the control block 9.

Since the assembly inspection apparatus of the configuration may recognize layout information about the position and the attitude of the assembly component 2 and the position and the attitude of the receiving assembly component 1 (or the assembly base), the state of the assembly component 2 put into the receiving assembly component 1 is inspected in consideration of a relative positional relationship between the assembly component and the receiving assembly component.

Further, the assembly processing apparatus of the configuration recognizes layout information of the assembly component 2 and the receiving assembly component 1 (or the assembly base) and performs operation for collecting the assembly component 2. Further, the assembly processing apparatus performs operation for putting the assembly component 2 into the receiving assembly component 1.

A preferred configuration of the marker 12 is now described.

First, a configuration for displaying a change in the density pattern Pc of the unit pattern mark 13 in the form of a dot image is mentioned as a preferred configuration of the marker 12. In the present configuration, a dot image indication is employed. Hence, an inkjet image forming apparatus or an electrophotographic image forming apparatus may form the unit pattern mark 13 of the marker 12.

Another configuration of the marker 12 includes four unit pattern marks 13 provided on a single plane of the assembly component. For instance, a position and an attitude of the assembly component may be determined without making one of the four unit pattern marks 13 on a plane differing from a plane on which the three unit pattern marks are provided.

Moreover, from the viewpoint of easy changing of the marker 12, it is better to form the marker displayed on a card that is removably attached to the assembly component.

Further, when the assembly component includes different types of assembly components, it is better to provide the marker 12 with four unit pattern marks 13 or more and type indication marks 14 used for recognizing type information other than layout information about a position and an attitude of the assembly component, as shown in FIG. 1B.

Further, in the present mode of implementation, a preferred configuration of the imaging tool 5 includes a configuration in which the imaging tool 5 of the assembly inspection apparatus doubles also as the prior-to-assembly imaging tool 5′.

Furthermore, a preferred supporting configuration for the imaging tool 5 includes a configuration in which the imaging tool 5 of the assembly inspection apparatus is provided so as to be movable along with the processing mechanism 10.

Moreover, in connection with a mode for capturing an image with a high accuracy by means of the imaging tool 5, the essential requirement for the processing mechanism 10 is to be able to place the imaging tool 5 at least at a non-face-up measurement position where the imaging plane of the imaging tool 5 does not directly face up the surface of the marker 12 provided on the assembly component in a view field range of the imaging tool 5. In this case, although a configuration in which the imaging tool is stationarily provided at the non-face-up measurement position is acceptable, it may also be possible to adopt a configuration in which the imaging tool 5 is movably supported so as to enable performance of measurement encompassing a face-up measurement position where the imaging plane of the imaging tool 5 faces up the surface of the marker 12 on the assembly component in the view field range of the imaging tool 5 and the non-face-up measurement position. Alternatively, it may also be possible to adopt a configuration in which the imaging tool 5 is movably supported so as to enable performance of measurement at the non-face-up measurement position in plural of stages.

### First Exemplary Embodiment

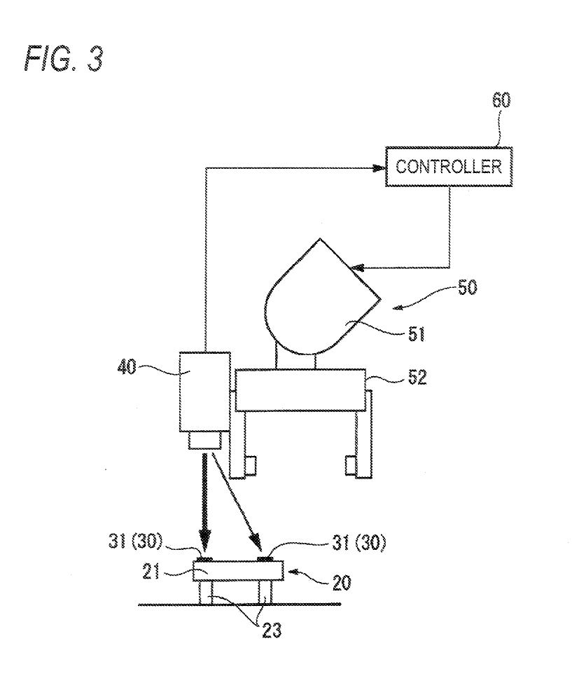

FIG. 3 is a descriptive view showing an overall structure of an assembly processing apparatus that serves as an assembly processing apparatus of a first exemplary embodiment.

<Overall Configuration of the Assembly Processing Apparatus>

In the drawing, the assembly processing apparatus automatically puts an assembly component 20 into an unillustrated receiving assembly component and inspects an assembly state of the assembly component.

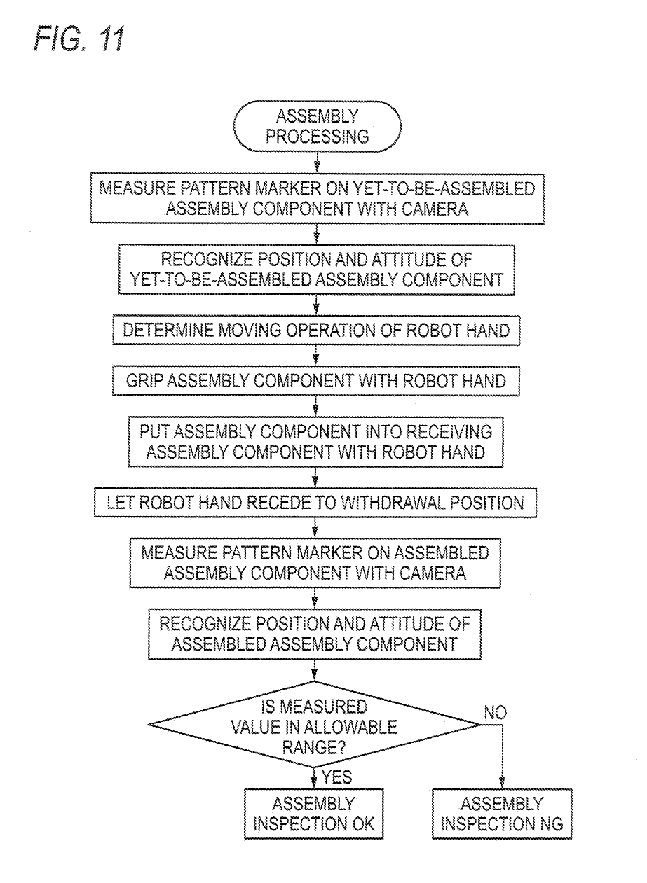

In the present exemplary embodiment, the assembly processing apparatus has a pattern marker 30 serving as a marker provided on the assembly component 20 used for recognizing layout information about a position and an attitude of the assembly component 20; a camera 40 that captures an image of the pattern marker 30 of the assembly component 20; a robot 50 serving as a support mechanism that grips the assembly component 20 and that puts the assembly component 20 into a receiving assembly component; and a controller 60 that controls imaging timing of the camera 40, receives an input of imaging information from the camera 40, and recognizes layout information about a position and an attitude of the assembly component 20, and controls motion of the robot 50 according to the thus-recognized layout information and along a flowchart shown in FIG. 11 to be described later.

In the exemplary embodiment, the robot 50 has a robot arm 51 that may be actuated by means of multiaxial joints. A robot hand 52 capable of performing gripping action is attached to an extremity of the robot arm 51. Processing operation to be performed by the robot hand 52 is instructed according to input locus information, such as a motion capture. A correction is made to the processing operation to be performed by the robot hand 52 according to the imaging information from the camera 40.

In the present exemplary embodiment, the camera 40 is fixed to a portion of the robot hand 52 and set at a predetermined measurement position by means of the robot hand 52.

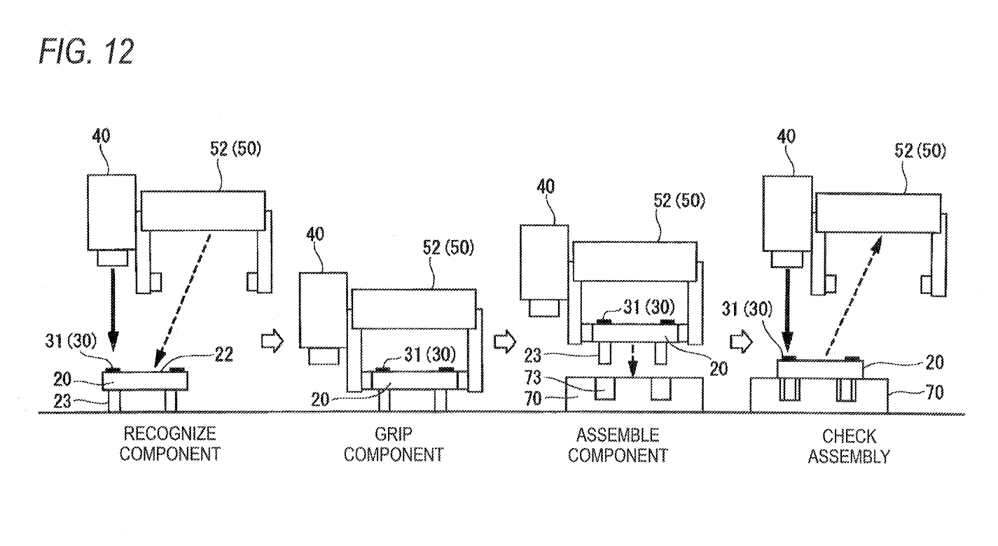

Although the assembly component 20 is arbitrarily selected according to an application, a pair of positioning legs 23 are provided on a bottom of for instance, a component main body 21 assuming the shape of a substantial rectangular parallelepiped. The assembly component 20 is assembled while put into a positioning indentation 73 of a receiving assembly component 70 (see FIG. 12).

<Pattern Marker>

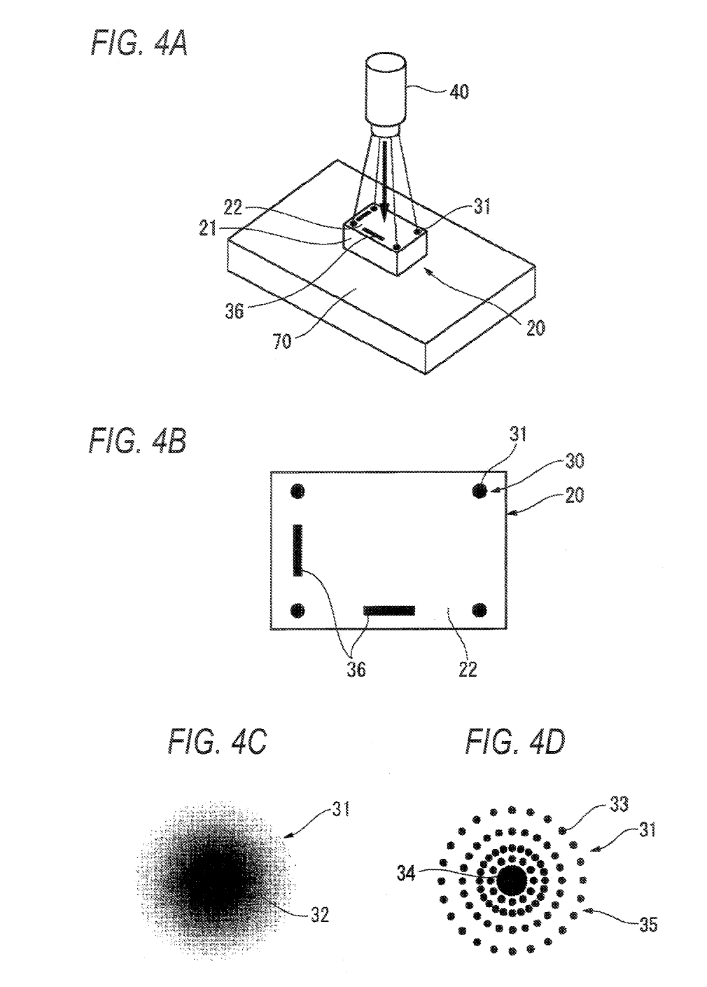

In the present exemplary embodiment, as shown in FIGS. 4A and 4B, a top surface 22 of the component main body 21 of the assembly component 20 is taken as a recognition reference plane. The pattern marker 30 has unit pattern markers 31 provided at the four corners of the top surface 22 and type indication marks 36 provided along two adjacent sides of the top surface 22 of the component main body 21. Reference numeral 70 in FIG. 4A designates a receiving assembly component.

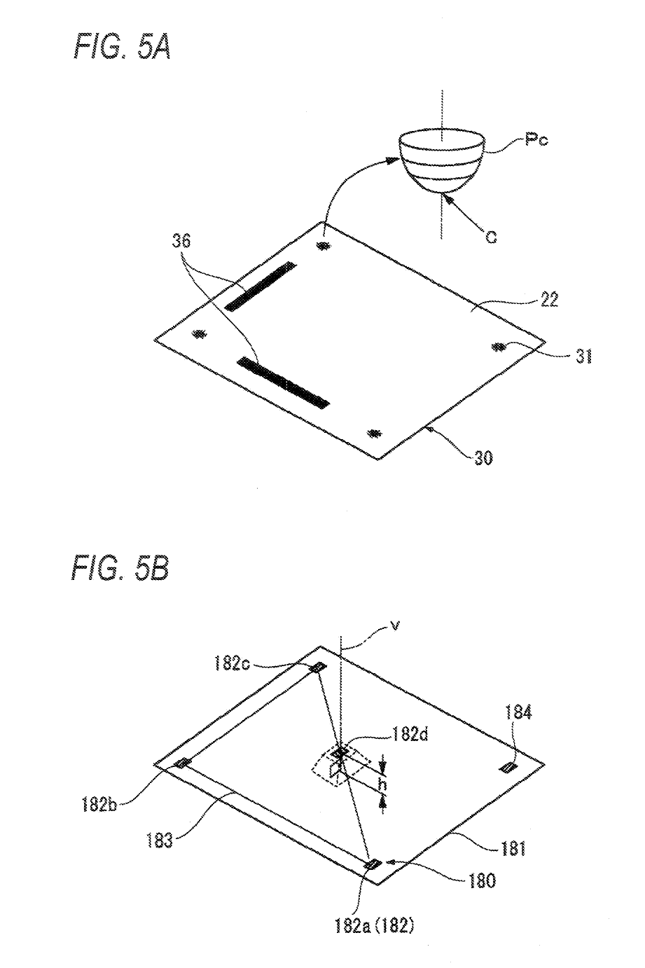

As shown in; for example, FIGS. 4C and 5A, one typical configuration of the unit pattern mark 31 is illustrated as a gradation 32 having a density pattern Pc that exhibits the highest density at the center position C and that sequentially changes so as to become less dense with an increasing distance toward a periphery of the mark.

As shown in FIGS. 4D and 5A, another typical configuration of the unit pattern mark 31 is illustrated as a dot pattern that exhibits the most dense distribution of dots 33 at the center position C, thereby forming a high density region 34, and a distribution of the dots 33 which becomes gradually coarser toward a periphery of the mark, thereby forming a low density region 35. In this case, the density distribution may be given to the unit pattern mark by means of changing a diameter size of the dot 33, spacing between the dots, and a layout position.

In particular, the dot pattern configuration is preferable, because the dot pattern is easily made by means of printing operation utilizing an inkjet image forming apparatus or an electrophotographic image forming apparatus.

Meanwhile, for instance, when the receiving assembly components 70 include plural of types (in terms of; for instance, color types, sizes, and the like), the type indication marks 36 act ID (identification) indications used for finding matching with receiving assembly components 70 of a corresponding type. In the present exemplary embodiment, the type indication marks 36 are provided at two locations but may also be provided at one location. Alternatively, there arises no problem even when the type indication marks are placed at three locations or more in a split manner.

—Comparison with an LED Indication Plate—

Unlike the pattern marker 30, an LED indication plate 180 shown in FIG. 5B has four LEDs 182 (182a to 182d) provided on a substrate 181. The three LEDs 182 (182a to 182c) of the four LEDs 182 are placed on a single plane of the substrate 181. The remaining one LED 182 (182d) is set on a vertical line “v” that is spaced “h” apart from a triangular reference plane 183 including the three LEDs 182 as apexes. A position and an attitude of the triangular reference plane 183 are determined from a positional relationship between the triangular reference plane 183 and the LED 182 (182d) on the vertical line “v.” Reference numeral 184 designates an LED for identification.

The position and the attitude of the assembly component 20 are surely recognized even by means of the LED indication plate 180; however, an electric power source for enabling use of the LED 182 is required. Therefore, the pattern marker 30 of the present exemplary embodiment is preferable in terms of such a power source being unnecessary.

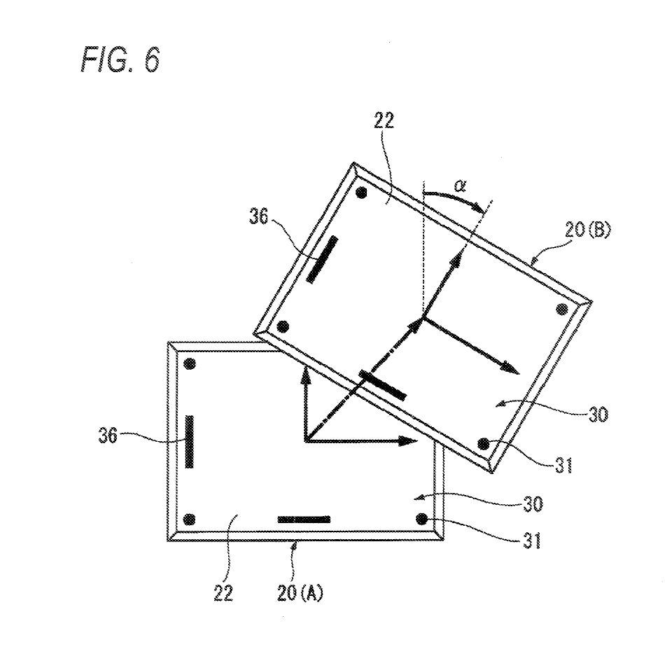

The LED indication plate 180 adopts a technique for enhancing accuracy of recognition of the position and the attitude by placing the four LEDs 182 in a three-dimensional manner. However, in the pattern marker 30, each of the unit pattern marks 31 has a density distribution whose density sequentially changes toward its periphery from its center position C. Therefore, the center position C of the density distribution (i.e., a point where the highest density is exhibited) may be calculated with high accuracy by means of a density distribution approximation expression. Therefore, even when four unit pattern marks 31 are placed on a single plane along with high accuracy of recognition of the unit pattern marks 31, the position of an apex corresponding to the center position C of the four unit pattern marks 31 is recognized. As a result, even if the assembly component 20 has changed from a position A to a position B in conjunction with occurrence of a rotation through a rotation angle α as shown in FIG. 6, the position and the attitude of the top plane 22 that is a recognition reference plane of the assembly component 20 will accurately be recognized.

In the present exemplary embodiment, the unit pattern marks 31 are provided in number of four on the single plane. However, the number of unit pattern marks is not limited to four. The unit pattern marks 31 may also be provided at; for instance, arbitrary six points. Specifically, the unit pattern marks may be selected as required, so long as the marks enable recognition of a three-dimensional position and a three-dimensional attitude of the assembly component. The essential requirement is to provide the unit pattern marks 31 in number of four or more, and locations where the unit pattern marks 31 are to be placed are not limited to a single plane but may also be set over different planes.

—Example Generation of the Pattern Marker—

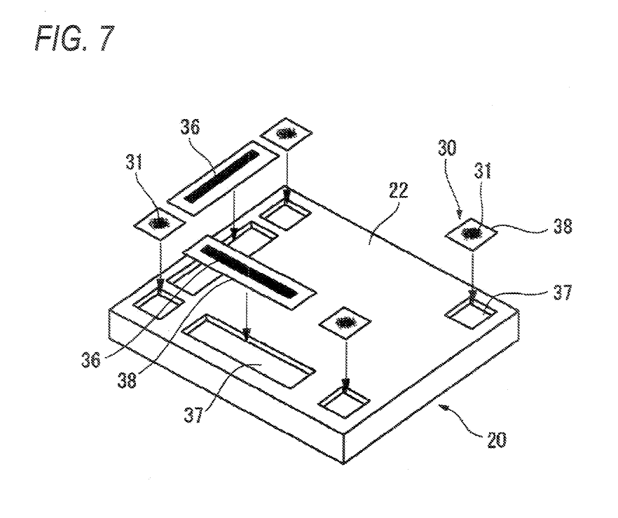

In the present exemplary embodiment, as shown in; for instance, FIG. 7, the pattern marker 30 includes attachment indentations 37 respectively to be provided at four corners and along two sides of the top surface 22 of the assembly component 20; and labels 38, each of which is printed with the unit pattern mark 31 and the type indication mark 36, are affixed to the respective attachment indentations 37. At this time, for instance, the depth of each of the attachment indentations 37 is selected so as to become equal to the thickness of each of the labels 38. The unit pattern marks 31 and the type indication marks 36 are set so as to become flush with the top surface 22 that serves as the recognition reference plane. Although the pattern marker 30 is set so as to become flush with the top surface 22 that is to serve as the recognition reference plane, the pattern marker 30 does not always need to become flush with the top surface 22. Further, in the present exemplary embodiment, the labels 38 are affixed to the assembly component by way of the attachment indentations 37. However, the labels may also be affixed directly to the top surface 22 that is to serve as a recognition reference plane, without involvement of the attachment indentations 37.

Moreover, in the present exemplary embodiment, it is desirable to place the unit pattern marks 31 of the pattern marker 30 while spaced apart from respective edges of the top surface 22 of the assembly component 20 by a certain extent.

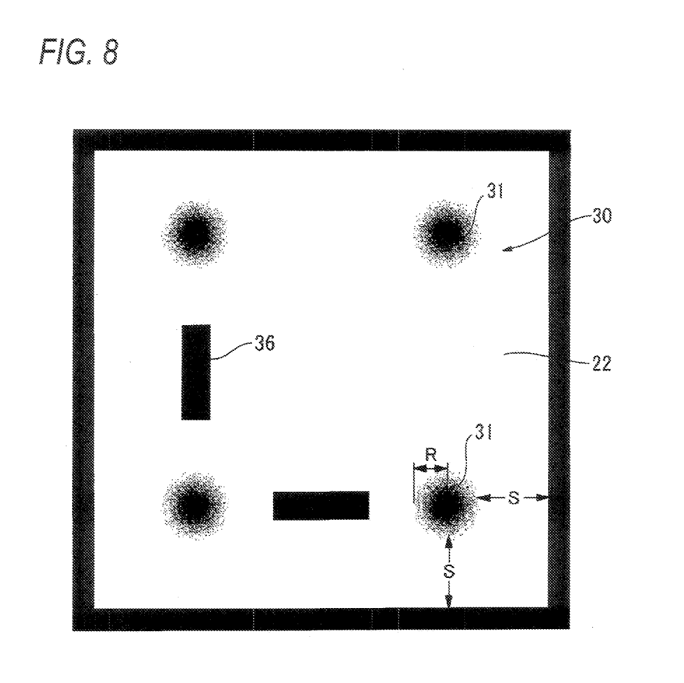

For instance, provided that the radius of the unit pattern mark 31 is taken as R and that an interval between the outermost contour of the unit pattern mark 31 and the edge of the top plane 22 is taken as S, fulfillment of S>2R is desirable as shown in FIG. 8. The relationship is based on an algorithm for detecting the center position C of the unit pattern mark 31 with high accuracy. A relationship of S>2R is fulfilled in such a way that a rectangular detection window to be superposed on a circular pattern of the unit pattern mark 31 does not overlap an edge (indicated by a black edge) of the top surface 22 of the assembly component 20. As a matter of course, a layout of the unit pattern mark 31 may arbitrarily be set, so long as a different detection algorithm is used for the pattern marker 30.

<Measurement Position of the Camera>

In the present exemplary embodiment, the camera 40 is disposed opposite the pattern marker 30 in order to make it possible to capture an image of the pattern marker 30 on the assembly component 20.

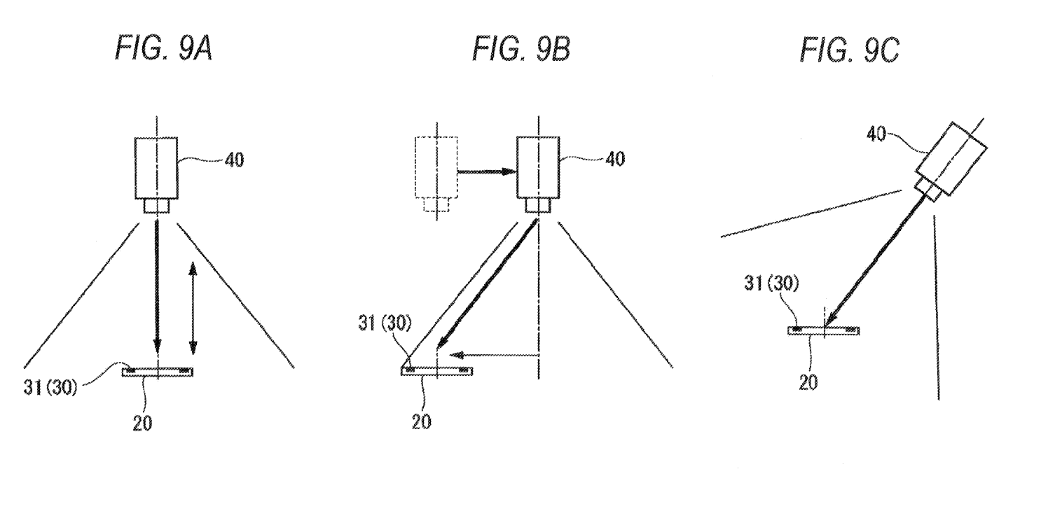

When study of a measurement position of the camera 40 achieved is performed at this time, configurations shown in FIGS. 9A to 9C are mentioned.

First, the configuration shown in FIG. 9A is for a case where a center position of an imaging plane (i.e., a center position of a view field range) of the camera 40 includes the center position C of the four unit pattern marks 31 of the pattern marker 30 on the assembly component 20 and where the center position is a face-up measurement position where the center position directly faces up to the top surface 22 that is the recognition reference plane.

The configuration induces a concern about deterioration of accuracy of measurement of a distance between the camera 40 and the pattern marker 30.

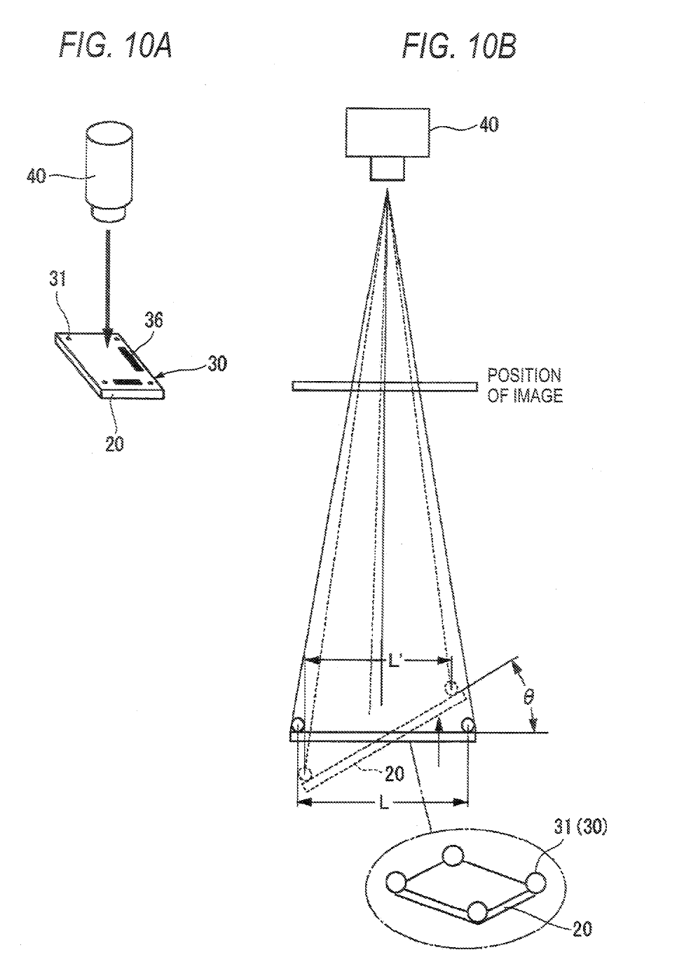

As shown in FIGS. 10A and 10B, when the camera 40 faces up to the pattern marker 30, a widthwise dimension between the unit pattern marks 31 of the pattern marker 30 is taken as an image size L to be captured by the camera 40. Further, if a change in image size occurred when the pattern marker 30 on the top surface 22 that is a recognition reference plane of the assembly component 20 is minutely changed by an amount of θ is taken as L′, a relationship of L′=L×cos θ is fulfilled.

It is understood from the above that the change L′ in image size becomes smaller than the original image size L, so that measurement accuracy will be deteriorated.

Next, the configuration shown in FIG. 9B relates to a case where the camera 40 is shifted from the position shown in FIG. 9A in parallel with the surface of the pattern marker 30 in such a way that the center position of the view field range of the camera 40 becomes offset from the center position C of the four unit pattern marks 31 of the pattern marker 30, to thus become offset from the face up measurement position shown in FIG. 9A.

In this case, when compared with the accuracy of measurement achieved in the case shown in FIG. 9A, the accuracy of measurement of the camera 40 is enhanced. However, the pattern marker 30 comes to a position that is offset from the center position C of the view field range of the camera 40, thereby inducing a concern that measurement accuracy might be deteriorated under influence of lens distortion of the camera 40. Even when a correction is made to lens distortion, measurement accuracy tends to fall at this time. Therefore, it is preferable to take an additional remedial measure.

On the contrary, a configuration shown in FIG. 9C relates to a case where the imaging plane of the camera 40 and the surface of the pattern marker 30 (equivalent to the top surface 22 of the assembly component 20 that is the recognition reference plane) do not face up to each other and where the center of the view field range of the camera 40 is placed in alignment with the center position of the four unit pattern marks 31 of the pattern marker 30. Namely, the configuration corresponds to a case where the imaging plane of the camera 40 is previously inclined with respect to the recognition reference plane of the pattern marker 30 as shown in FIG. 9C, so that measurement accuracy of the camera 40 is enhanced. Namely, on the assumption of cases shown in FIGS. 10A and 10B, the configuration shown in FIG. 9C may be considered to be a case where the imaging plane is tilted by a change L′ in image size. The change in image size L′ is considered to come to L as a result of the imaging plane having turned through θ. In this case, the change in image size is L=L′/cos θ. Accordingly, as the change in θ becomes larger, a change in the value of cos θ also becomes larger. A change in image size is accordingly given as a larger change.

Therefore, in the configuration shown in FIG. 9C, the measurement accuracy of the camera 40 is understood to be enhanced.

There arises no problem even when the tilt angle θ is selected as required. However, the tilt angle may range from 15° to 75°. From the viewpoint of enhancement of measurement accuracy, particularly selecting the tilt angle so as to come to around 45° is preferable.

As shown in; for instance, FIG. 3, in a configuration where the camera 40 is attached to the robot hand 52, a distance over which the robot hand 52 is moved to the position of the assembly component 20 after measurement becomes larger as the tilt angle θ becomes greater, which affects a production tact. Therefore, when consideration is given to the production tact, the minimum tilt angle θ achieved in a range where measurement accuracy may be assured is desirable.

<Assembly Processing>

Assembly processing performed by the assembly processing apparatus of the exemplary embodiment is now described. —Processing for Assembling Assembly Component—

First, the controller 60 performs processing pertaining to a flowchart shown in FIG. 11 and transmits a control signal to the camera 40 and the robot 50.

In the drawings, the controller 60 first measures the pattern marker 30 on the yet-to-be-assembled assembly component 20 by means of the camera 40 (a component recognition process shown in FIG. 12). Subsequently, the controller recognizes layout information about a position and an attitude of the yet-to-be-assembled assembly component 20.

The controller 60 then determines moving action of the robot hand 52 and lets the robot hand 52 grip the assembly component 20 (see a component grip process shown in FIG. 12) and lets the robot hand 52 put the assembly component 20 into the receiving assembly component 70 (see a component assemble process shown in FIG. 12).

The controller 60 subsequently determines that the robot hand 52 has finished performing operation for assembling the assembly component 20 and lets the robot hand 52 recede to a predetermined withdrawal position.

—Assembly Inspection of an Assembly Component—

The controller 60 measures the pattern marker 30 on an assembled assembly component 20 by means of the camera 40, thereby recognizing layout information about the position and the attitude of the assembled assembly component 20 (see a component check process shown in FIG. 12).

It is then checked whether or not a measured value falls within a predetermined allowable range. When the measured value is in the allowable range, the assembled component is determined to be acceptable (OK) through assembly inspection. On the contrary, when the measured value exceeds the allowable range, the assembled component is determined to be defective (NG) through assembly inspection.

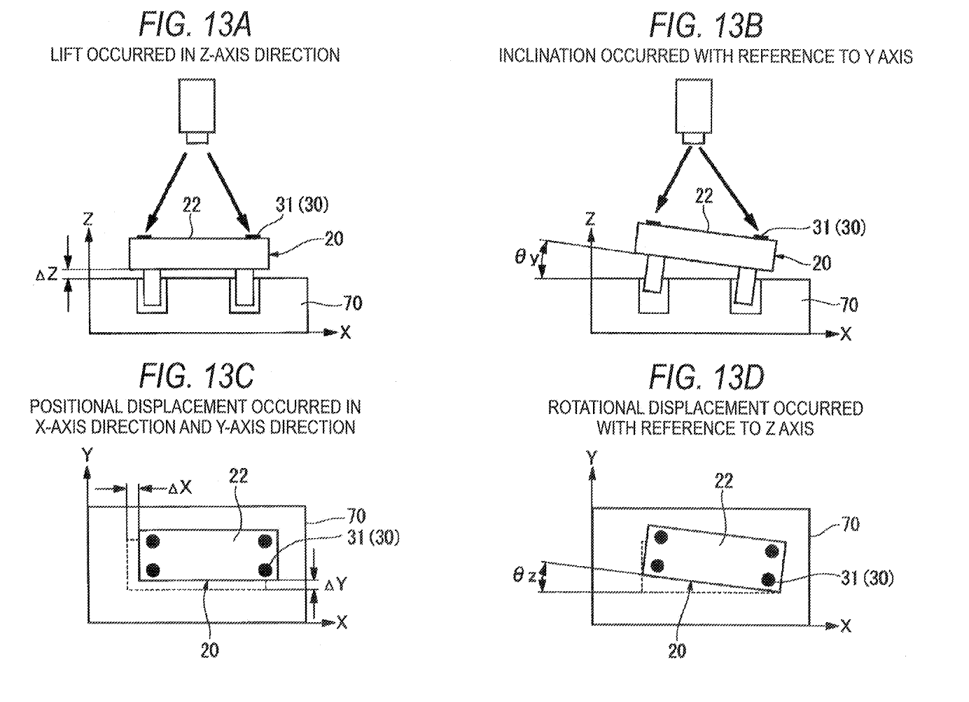

More specifically, as shown in FIG. 13A, the camera 40 acquires positional data pertaining to a Z-axis direction from the imaging information about each of the unit pattern marks 31 of the pattern marker 30, whereby a lift (ΔZ) occurred in the Z-axis direction may be calculated.

As shown in FIG. 13B, the camera 40 acquires positional data pertaining to surroundings of a Y axis from the imaging information about each of the unit pattern marks 31 of the pattern marker 30, thereby calculating an inclination (By) of the pattern marker with reference to the Y axis.

As shown in FIG. 13C, the camera 40 acquires positional data pertaining to the X-axis and Y-axis directions from the imaging information about each of the unit pattern marks 31 of the pattern marker 30, whereby positional displacements (ΔX, ΔY) occurred in both the X-axis direction and the Y-axis direction may be calculated.

Further, as shown in FIG. 13D, the camera 40 acquires positional data pertaining to surroundings of a Z axis from the imaging information about each of the unit pattern marks 31 of the pattern marker 30, whereby a rotational displacement (Δz) occurred with reference to the Z axis may be calculated.

<Assembly Inspection of an Assembly Component of a Comparative Mode>

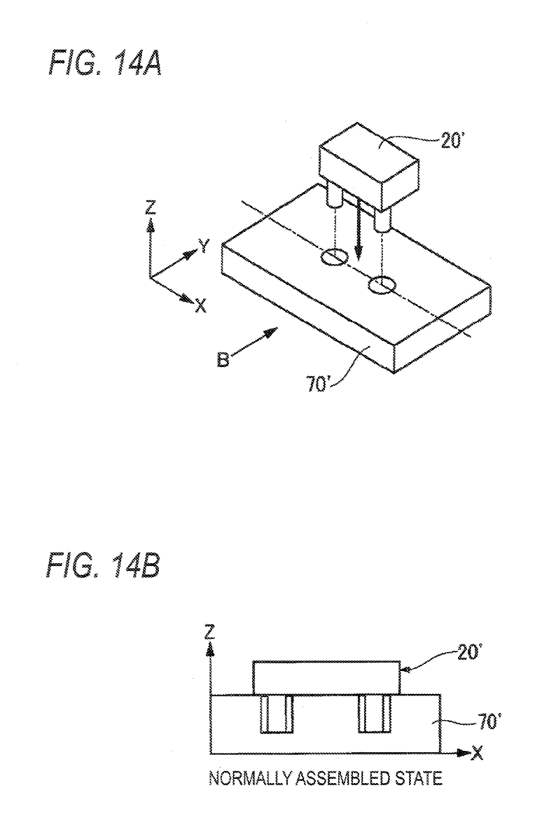

FIG. 14A shows a comparative mode in which a pattern marker is not provided on an assembly component 20′. As shown in FIG. 14B, if the assembly component 20′ is properly put into a receiving assembly component 70′, the assembly component 20′ will not be lifted in the Z-axis direction or inclined with reference to the Y axis.

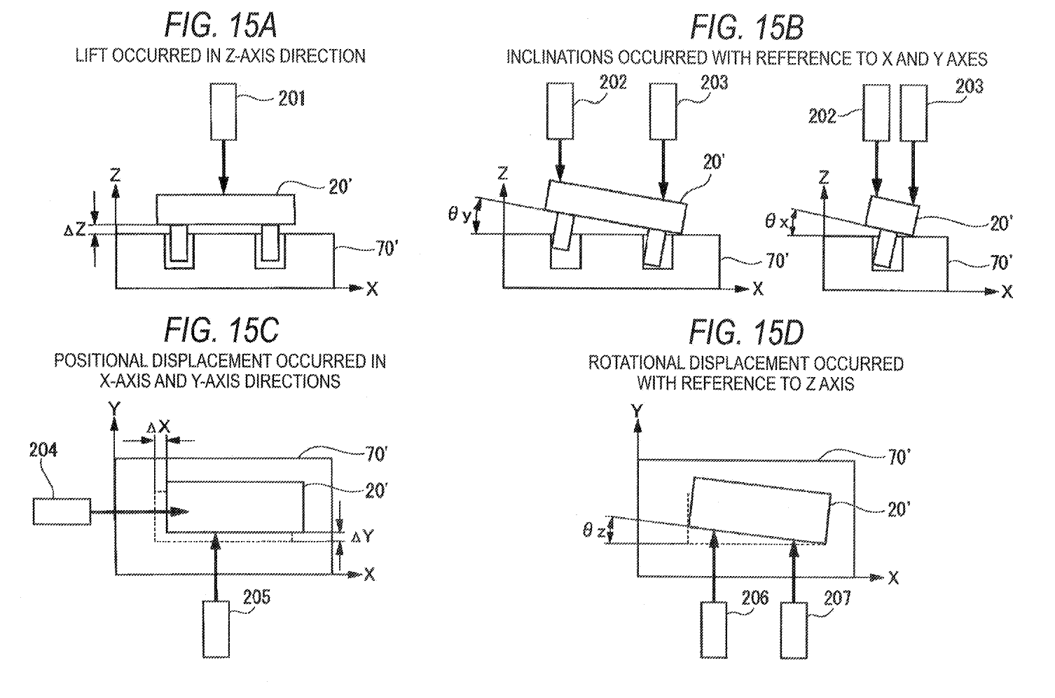

However, as shown in FIG. 15A, if the assembly component 20′ is not properly put into the receiving assembly component 70′, a lift (ΔZ) occurred in the Z-axis direction; for instance, may be calculated by acquiring positional data pertaining the Z-axis direction through use of a Z-axis displacement sensor 201 (e.g., a non-contact laser displacement sensor or a contact displacement sensor).

In addition, as shown in FIG. 15B, an inclination θx occurred with reference to the X axis and an inclination θy occurred with reference to the Y axis may be calculated from a difference between measured values output from two Z-axis displacement sensors 202 and 203 (non-contact laser displacement sensors or contact displacement sensors) separated apart from each other in both the X-axis direction and the Y-axis direction.

As shown in FIG. 15C, it is necessary to calculate a positional displacement (ΔX) occurred with reference to the X axis and a positional displacement (ΔY) occurred with reference to the Y axis, by acquiring X-axis positional data and Y-axis positional data through use of an X-axis displacement sensor 204 and a Y-axis displacement sensor 205 (e.g., a non-contact laser displacement sensor or a contact displacement sensor).

Further, as shown in FIG. 15D, a rotational displacement θz occurred with reference to the Z axis; for instance, may be calculated from a difference between measured values from Y-axis displacement sensors 206 and 207 (e.g., non-contact laser displacement sensors and contact displacement sensors) separated from each other in the X-axis direction.

As mentioned above, some of the sensors are capable of being shared in order to calculate the respective displacements. However, the large number of displacement sensors 201 to 207 are still required, which in turn raises a concern about complication of a facility structure.

### Second Exemplary Embodiment

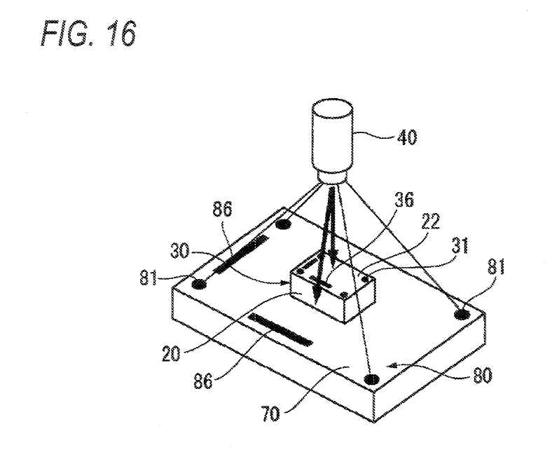

FIG. 16 is a descriptive view showing a principal block of an assembly processing apparatus serving as an assembly processing apparatus of a second exemplary embodiment.

In the exemplary embodiment, the assembly processing apparatus is substantially analogous to its counterpart described in connection with the first exemplary embodiment in terms of a basic structure. However, unlike the first exemplary embodiment, a pattern marker 80 substantially analogous to the pattern marker 30 of the assembly component 20 is provided even on the top surface 22 of the receiving assembly component 70. In the present exemplary embodiment, the pattern marker 80 has unit pattern marks 81 provided at four corners of the top surface 22 and type indication marks 86 to be provided along two sides of the top surface 22.

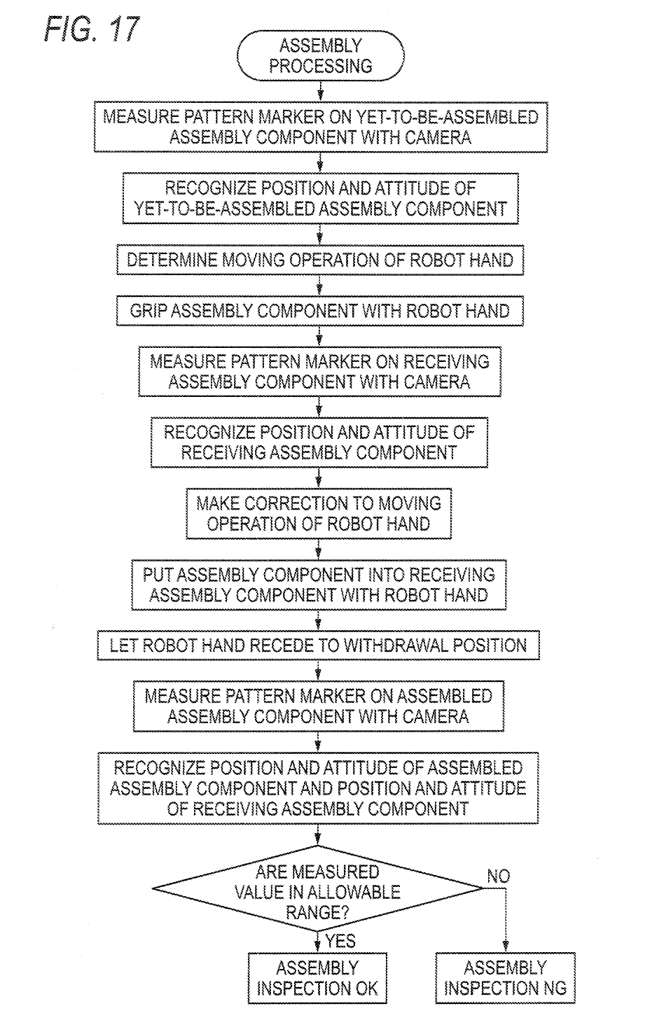

In the present exemplary embodiment, the camera 40 captures an image of the pattern marker 30 of the assembly component 20, as well as capturing an image of the pattern marker 80 of the receiving assembly component 70. The controller 60 analogous to its counterpart described in connection with the first exemplary embodiment is to control the camera 40 and the robot 50 (see the first exemplary embodiment) along the flowchart shown in FIG. 17.

Operation of the assembly processing apparatus of the present exemplary embodiment is now described by reference to FIG. 17.

First, the controller 60 performs processing pertaining to the flowchart shown in FIG. 17 and transmits a control signal to the camera 40 and the robot 50.

In the drawing, the controller 60 measures the pattern marker 30 of the yet-to-be-assembled assembly component 20

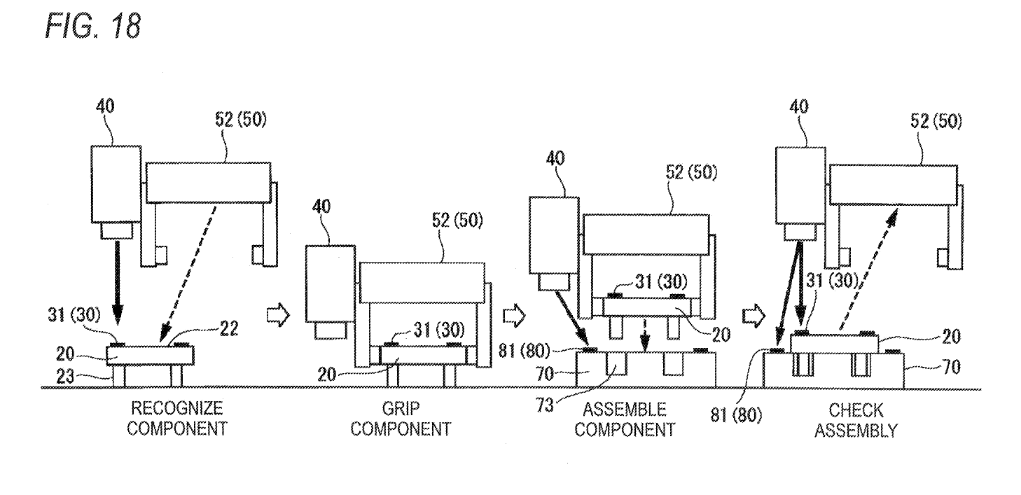

by means of the camera 40 (see a component recognition process shown in FIG. 18); and subsequently recognizes layout information about the position and the attitude of the yet-to-be-assembled assembly component 20.

Subsequently, the controller 60 determines moving motion of the robot hand 52 and lets the robot hand 52 grip the assembly component 20 (see a component grip process shown in FIG. 18).

The controller 60 then measures the pattern marker 80 of the receiving assembly component 70 by means of the camera 40, to thus recognize layout information about a position and an attitude of the receiving assembly component 70 and make a correction to the moving motion of the robot hand 52; and puts the assembly component 20 to the receiving assembly component 70 by means of the robot hand 52 (see a component assembly process shown in FIG. 18).

The controller 60 then determines that the robot hand 52 has finished processing for assembling the assembly component 20 and lets the robot hand 52 recede to the predetermined withdrawal position.

The controller 60 subsequently measures the pattern marker 30 on the assembled assembly component 20 and the pattern marker 230 on the receiving assembly component 70 by means of the camera 40, thereby recognizing layout information about the position and the attitude of the assembled assembly component 20 and layout information about the position and the attitude of the assembled receiving assembly component 70 (see a component check process shown in FIG. 18).

It is then checked, from a relative positional relationship between the pattern markers, whether or not a measured value falls within a predetermined allowable range. When the measured value is in the allowable range, the assembled component is determined to be acceptable (OK) through assembly inspection. On the contrary, when the measured value exceeds the allowable range, the assembled component is determined to be defective (NG) through assembly inspection.

In particular, in the present exemplary embodiment, layout information even about the position and the attitude of the receiving assembly component 70 is also recognized. Therefore, a state of the assembly component 20 put into the receiving assembly component 70 is checked more accurately than in the case of the first exemplary embodiment because, in addition to accuracy of fitting of the assembly component 20 into the receiving assembly component 70 being maintained superior, the relative positional relationship between the assembly component 20 and the receiving assembly component 70 is also recognized in the assembly inspection processes subsequent to assembly.

In the present exemplary embodiment, the layout information even about the position and the attitude of the receiving assembly component 70 is also recognized in the assembly inspection process. However, the layout information even about the position and the attitude of the receiving assembly component 70 is recognized on occasion of the assembly component 20 being put into the receiving assembly component 70. Therefore, processing for recognizing the layout information about the receiving assembly component 70 may also be omitted from the assembly inspection process.

### Third Exemplary Embodiment

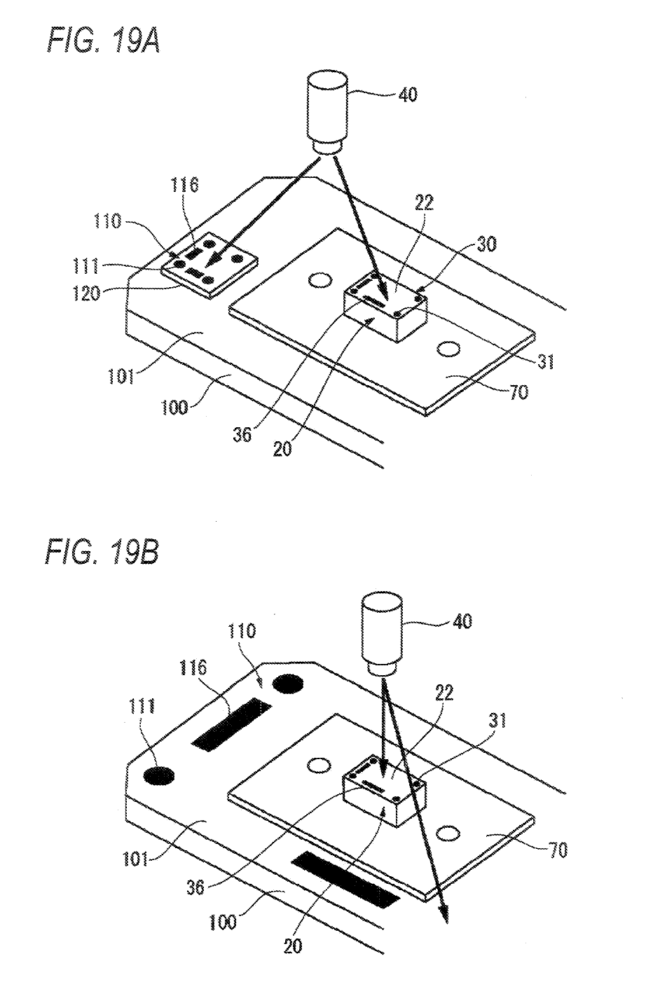

FIG. 19A shows a principal block of an assembly processing apparatus of a third exemplary embodiment.

In the drawing, the assembly processing apparatus is substantially analogous to its counterpart described in connection with the second exemplary embodiment. Unlike the second exemplary embodiment, the receiving assembly component 70 is positioned at a predetermined area on an assembly jig (equivalent to an assembly base) 100, and a pattern marker 110 analogous to the pattern marker 80 is provided on a portion of the assembly jig 100.

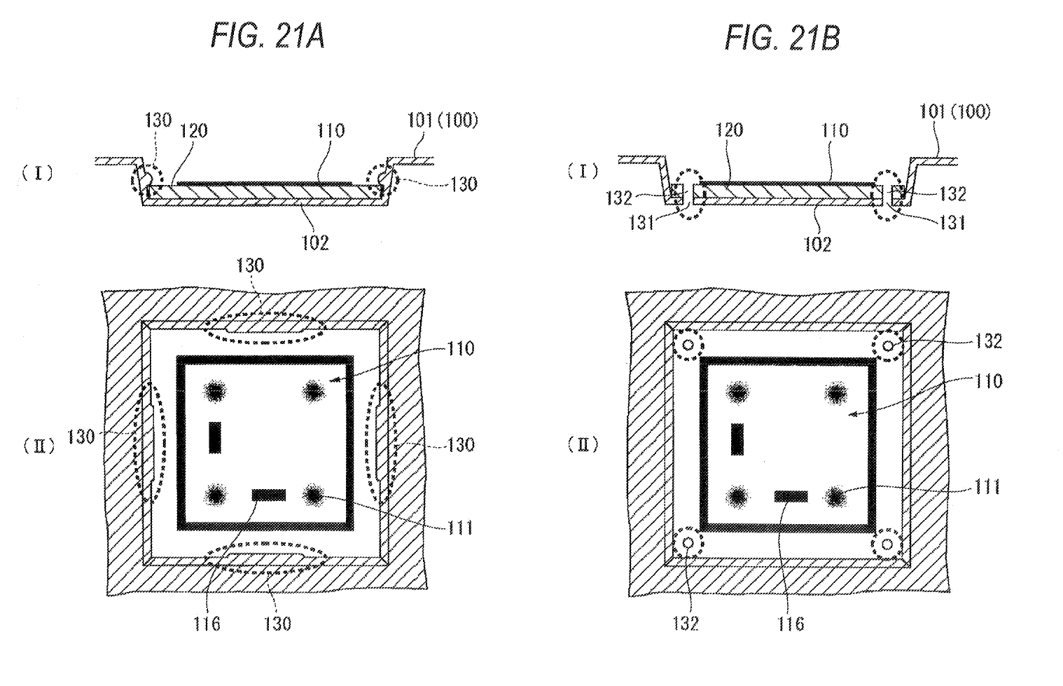

In the present exemplary embodiment, the pattern marker 110 is printed on a front surface of a card 120. The card 120 is fixed to an attachment indentation 102 (see FIG. 21) formed in a portion of a top surface 101 of the assembly jig 100.

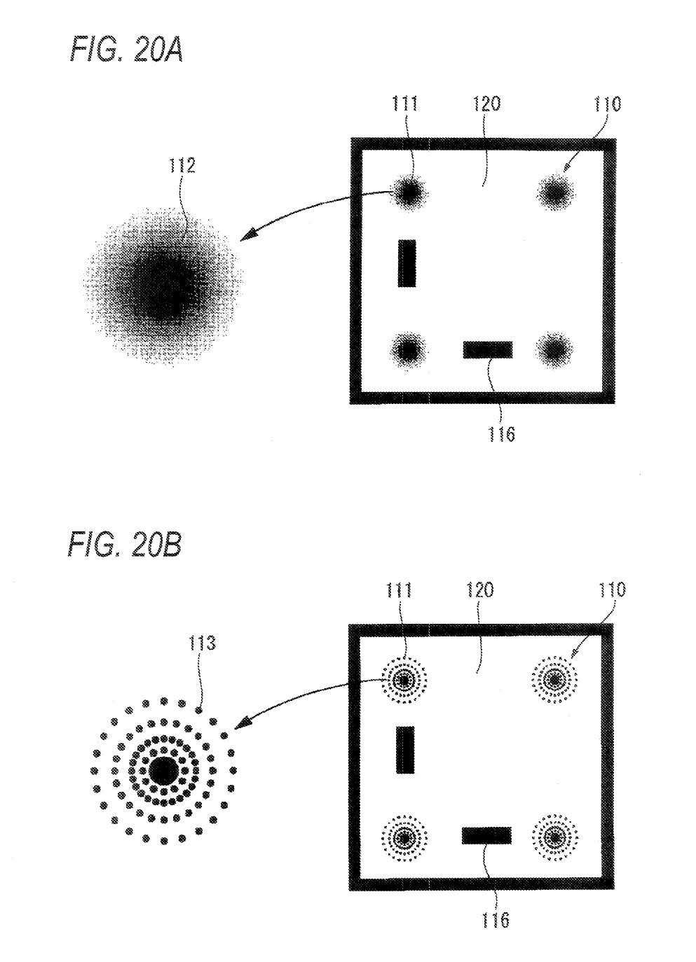

The pattern marker 110 includes several configuration; for instance, a configuration including unit pattern marks 111 that are made up of gradations 112 to be provided at respective four corners of the front surface of the card 120 and type indication marks 116 to be provided along two sides of the front surface of the card 120, as shown in FIG. 20A; and a configuration including the unit pattern marks 111 that are made up of for instance, dot patterns 113 to be provided at the respective four corners of the front surface of the card 120, and the type indication marks 116 to be provided along the two sides of the front surface of the card 120 as shown in FIG. 20B.

<Method for Fixing the Pattern Marker>

The following is provided as a method for fixing the pattern marker 110.

A configuration shown in FIG. 21A includes providing elastically deformable press protrusions 130 on a peripheral wall of the attachment indentation 102 formed in the top surface 101 of the assembly jig 100; placing the card 120 printed with the pattern marker 110 in the attachment indentation 102 while the press protrusions 130 are being elastically deformed; and holding down a periphery of the card 120 placed in the attachment indentation 102 by means of the press protrusions 130. In the exemplary embodiment, the card 120 may be removed while the press protrusions 130 are being elastically deformed.

The configuration shown in FIG. 21B includes opening mount holes 131 and 132 both in the bottom of the attachment indentation 102 formed in the top surface 101 of the assembly jig 100 and at four corners of the card 120 printed with the pattern marker 110. The card 120 is fixed to the interior of the attachment indentation 102 by means of unillustrated fastening tools.

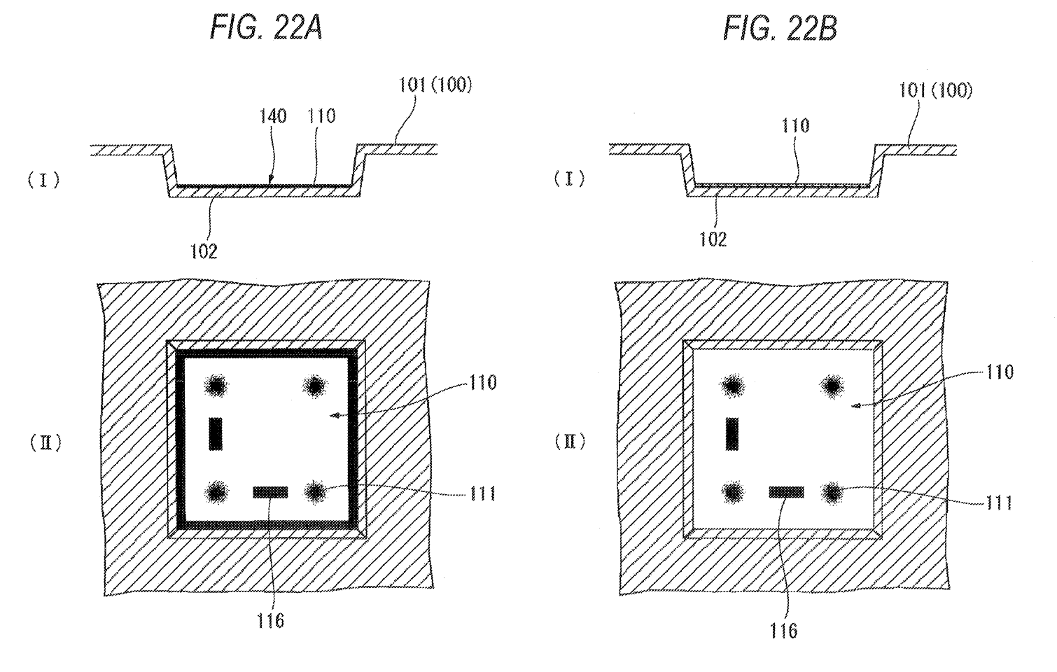

Further, in a configuration shown in FIG. 22A, the pattern marker 110 is printed on a label 140 made of paper or a resin, and the label 140 is affixed to the bottom of the attachment indentation 102 of the assembly jig 100.

Moreover, in a configuration shown in FIG. 22B, the pattern marker 110 is printed directly on the bottom of the attachment indentation 102 of the top surface 101 of the assembly jig 100.

As mentioned above, in the present exemplary embodiment, a portion of the assembly jig 100 is provided with the pattern marker 110. The camera 40 measures the pattern marker 110 on the portion of the assembly jig 100, thereby recognizing layout information about the position and the attitude of the assembly jig 100. The layout information about the position and the attitude of the receiving assembly component 70 may be recognized on the basis of the layout information about the assembly jig. Therefore, when the assembly component 20 is put into the receiving assembly component 70, processing for putting the assembly component 20 into the receiving assembly component 70 is accurately performed.

Moreover, after putting the assembly component 20 into the receiving assembly component 70 has finished, the pattern marker 30 on the assembly component 20 and the pattern marker 110 on the assembly jig 100 are measured, whereby a relative positional relationship between the assembly component 20 and the receiving assembly component 70 is recognized on the basis of the layout information about the position and the attitude of the assembly component 20 and the layout information about the position and the attitude of the assembly jig 100. This makes it possible to check a state of the assembly component 20 being put into the receiving assembly component 70.

In the present exemplary embodiment, as shown in FIG. 19A, the pattern marker 110 is provided on a portion of the attachment indentation 102 of the top surface 101 of the assembly jig 100. The location of the pattern marker is not limited to that position. As a matter of course, as shown in FIG. 19B, the pattern marker 110 may also be provided at four corners and along two sides of the top surface 101 of the assembly jig 100.

### Fourth Exemplary Embodiment

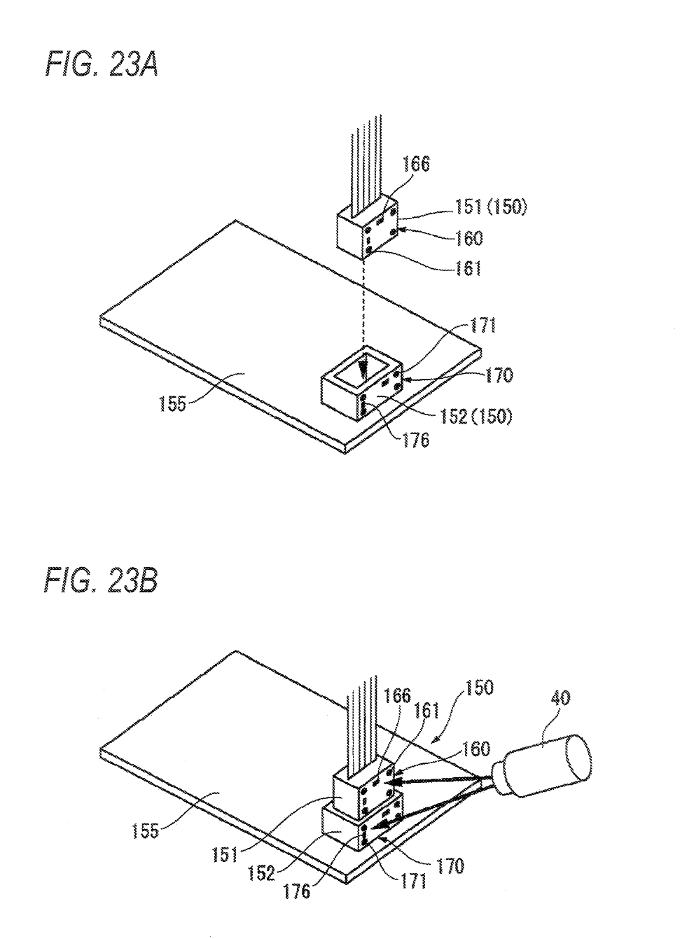

FIGS. 23A and 23B show a principal block of an assembly processing apparatus for inspecting a state of insertion of a connector device.

FIG. 23A is a descriptive view showing a state in which a male connector 151 and a female connector 152, which are elements of a connector device 150, are not yet coupled together by insertion. FIG. 23B is a descriptive view showing a state in which the male connector and the female connector are coupled together by insertion.

In the present exemplary embodiment, a pattern marker 160 is provided on one side surface of the male connector 151, and a pattern marker 170 is provided on one side surface of the female connector 152, wherein both side surfaces are on the same side. The pattern marker 160 has unit pattern marks 161 provided at four corners on the side surface and type indication marks 166 provided along two sides of the same side surface. Further, the pattern marker 170 has unit pattern marks 171 provided at four corners on the side surface and type indication marks 176 provided along two sides of the same side surface.

As shown in FIG. 23B, after the male connector 151 has been assembled into the female connector 152, the camera 40 measures the pattern markers 160 and 170.

According to the measured imaging information, an unillustrated controller recognizes layout information about a position and an attitude of the pattern marker 160 on the male connector 151 and a position and an attitude of the pattern marker 170 on the female connector 152; and calculates a relative positional relationship between the connectors, thereby checking an assembled state of the connectors.

In the exemplary embodiment, the pattern marker 160 on the male connector 151 and the pattern marker 170 on the female connector 152 are provided with different type indication marks (IDs), whereby layout information about the male connector 151 and layout information about the female connector 152 may accurately be recognized.

In the exemplary embodiment, the male connector 151 is provided with the pattern marker 160, and the female connector 152 is provided with the pattern marker 170. In; for instance, a configuration in which the female connector 152 is provided at a predetermined area on a printed board 155, the pattern marker 170 is provided on the printed board 155 in lieu of the female connector 152. A relative positional relationship between the male connector and the female connector may also be recognized by means of the pattern marker on the printed board and the pattern marker 160 of the male connector 151 that are inserted and put into the female connector 152.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. An assembly inspection apparatus comprising:
a marker having four or more unit pattern marks which are provided, at a predetermined positional relationship, in a portion of an assembly component to be put into a receiving assembly component and which are formed in such a way that a density pattern sequentially changes from a center position to a periphery of the pattern mark;
an imaging tool that is disposed opposite the assembly component put into the receiving assembly component and that captures an image of the marker;
a layout information recognition block that recognizes layout information about a position and an attitude of the assembly component put into the receiving assembly component by use of at least imaging information about the marker whose image has been captured by the imaging tool; and
an assembly inspection block that inspects, according to layout information recognized by the layout information recognition block, whether or not a superior assembly state is achieved.

2. The assembly inspection apparatus according to claim 1, wherein the marker corresponds to indicating a change in density pattern of the unit pattern marks in the form of dot images.

3. The assembly inspection apparatus according to claim 1, wherein the marker has four unit pattern marks placed on a same plane of the assembly component.

4. The assembly inspection apparatus according to claim 1, wherein the marker is provided on a card removably attached to the assembly component.

5. The assembly inspection apparatus according to claim 1, wherein the marker has four unit pattern marks or more and type indication marks used for recognizing type information other than layout information about a position and an attitude of the assembly component.

6. An assembly inspection apparatus comprising:
a marker having four or more unit pattern marks which are provided, at a predetermined positional relationship, in a portion of a receiving assembly component, a portion of an assembly base on a predetermined area of which the receiving assembly component is to be placed and a portion of an assembly component to be put into the receiving assembly component and which are formed in such a way that a density pattern sequentially changes from a center position to a periphery of the pattern mark;
an imaging tool that is disposed opposite the assembly component put into the receiving assembly component and that captures an image of the marker on the receiving assembly component or an image of the marker on the assembly base and an image of the marker on the assembly component;
a layout information recognition block that recognizes layout information about a position and an attitude of a receiving assembly component and a position and an attitude of the assembly component put into the receiving assembly component, by use of at least imaging information about the marker whose image has been captured by the imaging tool; and
an assembly inspection block that inspects, according to both of the pieces of layout information recognized by the layout information recognition block, whether or not a superior assembly state is achieved.

7. The assembly inspection apparatus according to claim 6, wherein the marker corresponds to indicating a change in density pattern of the unit pattern marks in the form of dot images.

8. The assembly inspection apparatus according to claim 6, wherein the marker has four unit pattern marks placed on a single plane of the assembly component.

9. The assembly inspection apparatus according to claim 6, wherein the marker is provided on a card removably attached to the assembly component.

10. The assembly inspection apparatus according to claim 6, wherein the marker has four unit pattern marks or more and type indication marks used for recognizing type information other than layout information about a position and an attitude of the assembly component.

11. An assembly processing apparatus comprising:
an assembly inspection apparatus according to claim 1;
a prior-to-assembly imaging tool that is disposed opposite a yet-to-be-assembled assembly component to be put into a receiving assembly component and that captures an image of a marker on the assembly component;
a prior-to-assembly layout information recognition block that recognizes layout information about a position and an attitude of the yet-to-be-assembled assembly component to be put into the receiving assembly component, by use of at least imaging information about the marker whose image has been captured by the prior-to-assembly imaging tool;
a control block that generates a control signal according to layout information about the position and the attitude of the assembly component recognized by the prior-to-assembly layout information recognition block and that controls assembly component collection processing operation and operation for putting the assembly component into the receiving assembly component; and
a processing mechanism that performs the assembly component collection processing operation and the operation for putting the assembly component into the receiving assembly component, according to the control signal generated by the control block.

12. An assembly processing apparatus comprising:
an assembly inspection apparatus according to claim 6;
a prior-to-assembly imaging tool that is disposed opposite a yet-to-be-assembled assembly component to be put into a receiving assembly component and captures an image of a marker on the assembly component and an image of a marker on the yet-to-be-assembled receiving assembly component into which the assembly component is put or that is disposed opposite an assembly base and captures an image of a marker on the receiving assembly component or an image of a marker on the assembly base;
a prior-to-assembly layout information recognition block that recognizes layout information about a position and an attitude of the yet-to-be-assembled assembly component to be put into the receiving assembly component and layout information about a position and an attitude of the receiving assembly component, by use of at least imaging information about the marker whose image has been captured by the prior-to-assembly imaging tool;
a control block that generates a control signal according to layout information about the position and the attitude of the assembly component recognized by the prior-to-assembly layout information recognition block and the layout information about the position and the attitude of the receiving assembly component recognized by the prior-to-assembly layout information recognition block, and that controls assembly component collection processing operation and operation for putting the assembly component into the receiving assembly component; and
a processing mechanism that performs assembly component collection processing operation and operation for putting the assembly component into the receiving assembly component, according to the control signal generated by the control block.

13. The assembly processing apparatus according to claim 11, wherein the imaging tool of the assembly inspection apparatus doubles also as the prior-to-assembly imaging tool.

14. The assembly processing apparatus according to claim 13, wherein the imaging tool of the assembly inspection apparatus is provided so as to be movable in conjunction with the processing mechanism.

15. The assembly processing apparatus according to claim 14, wherein the processing mechanism place at least the imaging tool at a non-face-up measurement position where an imaging plane of the imaging tool does not directly face up a surface of the marker provided on the assembly component and in a view field range of the imaging tool.
